(19) United States
(12) Patent Application Publication
(10) Pub. No.: US 2026/0249535 A1
(43) Pub. Date: Aug. 27, 2026

(54) BLOW UP RATIOS IN FOAMED SHEET PRODUCTION PROCESSES

(71) Applicant: Eastman Chemical Company, Kingsport, TN (US)

(72) Inventors: Michael Eugene Donelson, Kingsport, TN (US); Rahul Shankar, Kingsport, TN (US); Goliath Beniah, York, PA (US); Michael Wandell Cradic, Kingsport, TN (US); David Wayne Compton, Weber City, VA (US)

(73) Assignee: Eastman Chemical Company, Kingsport, TN (US)

(21) Appl. No.: 19/159,938

(22) PCT Filed: Feb. 27, 2024
(86) PCT No.: PCT/US2024/017386

§ 371 Date: Aug. 26, 2025

Related U.S. Application Data
(60) Provisional application No. 63/487,027, filed on Feb. 27, 2023.

(51) Int. Cl. B29C 48/09; B29C 44/50; B29C 48/00; B29K 1/00; B29K 105/00; B29L 7/00; B29L 23/00

(52) U.S. Cl. CPC B29C 48/09; B29C 44/507; B29C 48/0012; B29K 2001/08; B29K 2105/0047; B29K 2995/006; B29L 2007/00; B29L 2023/00

(57) ABSTRACT

Compositions, systems, and methods for use in foam sheet production processes. Such processes generally comprise extruding a composition and drawing the extrudate over a forming mandrel. The ratio of the forming mandrel diameter to the extruder die diameter is referred to as the “blow up ratio” (BUR). The compositions, systems, and methods according to embodiments are directed to blow up ratios in cellulose ester foam sheet production that aim to provide for maximum sheet production output without rupture of the extrudate material.

### BACKGROUND OF THE INVENTION

Many foam articles, such as food-packaging articles, are single-use items that are intended to be disposed of after use. One commercially important material used to make foam articles is polystyrene. However, polystyrene is neither compostable nor biodegradable. Moreover, some municipalities, states, and countries have enacted, or are considering enacting, bans on the use polystyrene-based foams. Thus, it would be desirable to find alternative materials for use in foam articles, as well as viable compositions, methods, and systems for producing such articles.

During foam sheet production processes, an extruded composition is generally drawn over a forming mandrel. In traditional processes using polystyrene, blow up ratios (i.e., the ratio of the forming mandrel diameter to the extruder die diameter) may be in the range of 4 to 5. However, different compositions (such as cellulose ester compositions) may have different acceptable blow up ratios to avoid rupturing of the material. Thus, it would be desirable to find acceptable blow up ratios for cellulose ester compositions and to find compositions and processes for increasing the blow up ratios for cellulose ester compositions to thereby improve the output of foam sheet material.

### SUMMARY OF THE INVENTION

In one embodiment or in combination with any other embodiment mentioned herein, there is provided a foam sheet forming process. The process comprises: (a) extruding a composition comprising cellulose ester through an annular die having a die inner diameter (X) to form a tubular extrudate; and (b) drawing the tubular extrudate over a forming mandrel having a mandrel outer diameter of 2.1X to 3.9X.

In one embodiment or in combination with any other embodiment mentioned herein, there is provided a foam sheet forming process. The process comprises: (a) extruding a composition comprising cellulose ester through an annular die having a die inner diameter (X) to form a tubular extrudate; and (b) drawing the tubular extrudate over a forming mandrel having a mandrel outer diameter of at least 3.3X.

In one embodiment or in combination with any other embodiment mentioned herein, there is provided a foam sheet forming process. The process comprises: (a) extruding a composition through an annular die having a die inner diameter (X) to form a tubular extrudate; and (b) drawing the tubular extrudate over a tapered forming mandrel comprising a first end proximal to the annular die having a first diameter (Y) and a second end distal to the annular die having a second diameter, wherein the second diameter (Y) is at least 3.3X, and the first diameter (Y) is less than the second diameter.

### BRIEF DESCRIPTION OF THE DRAWINGS

FIG. 1 is a schematic diagram illustrating a biodegradable article forming process according to embodiments of the present invention;

FIG. 2 is a schematic diagram illustrating another biodegradable article forming process according to embodiments of the present invention;

FIG. 3 is a schematic diagram illustrating an extrusion section that may be used in the article forming processes of FIGS. 1 and/or 2, according to embodiments of the present invention;

FIG. 4 is a schematic diagram illustrating another extrusion section that may be used in the article forming process of FIGS. 1 and 2, according to embodiments of the present invention;

FIG. 5 is a schematic diagram illustrating a sheet forming section that may be used in the article forming processes of FIGS. 1 and/or 2, according to embodiments of the present invention; and

FIG. 6 is a schematic diagram illustrating an exemplary forming mandrel comprising a heat transfer conduit adjacent the surface of the mandrel, according to embodiments of the present invention.

### DETAILED DESCRIPTION

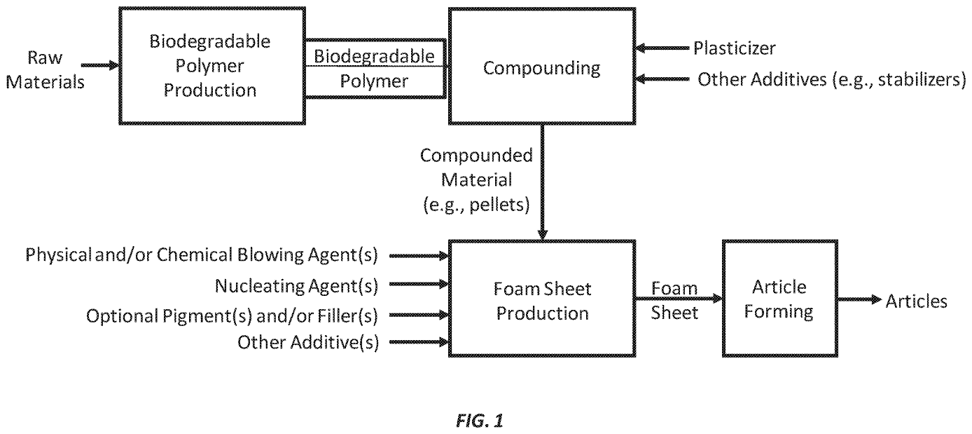

Embodiments are generally directed to methods, systems, and compositions for forming biodegradable particulate materials (e.g., pellets), foam sheets, and articles. In particular embodiments, the methods, systems, and compositions described herein provide for acceptable and optimal blow up ratios when drawing cellulose ester melt compositions over a forming mandrel in foam sheet forming processes. In some same or other embodiments, the blow up ratios may be increased by methods and compositional additives that, for example, increase the elasticity and/or melt strength of the melt compositions. Exemplary processes including the methods, systems, and compositions are depicted in FIGS. 1-6 and are described in greater detail below.

### Methods and Systems

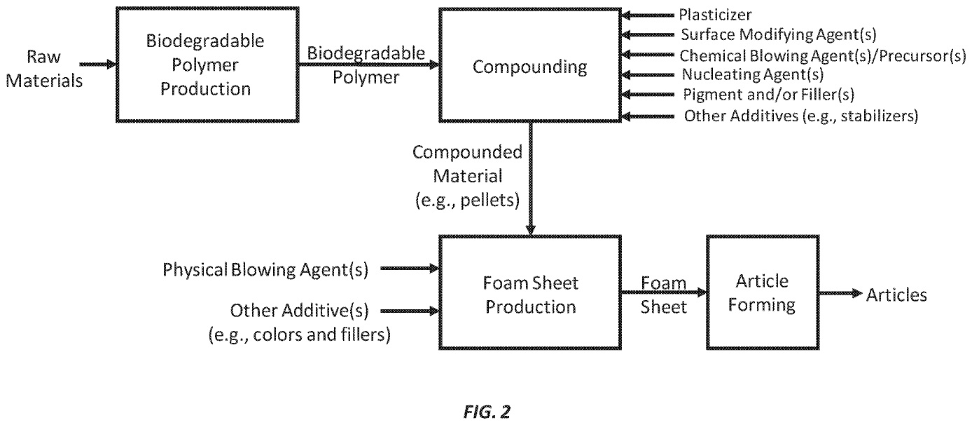

As shown in FIG. 1 and FIG. 2, raw materials may be introduced to a biodegradable polymer production process, which produces a biodegradable polymer material. In one embodiment or in combination with any other embodiment mentioned herein, the biodegradable polymer material comprises one or more cellulose esters. The one or more cellulose esters may comprise cellulose acetates. In such embodiments, the raw materials may comprise a pulp, such as wood pulp and/or cotton pulp. The pulp may be a dissolving-grade pulp and/or a paper-grade pulp. The cellulose in the pulp may esterified, for example with an acetic acid, to form the biodegradable cellulose ester polymer, such as a cellulose acetate polymer.

The biodegradable polymer material may then be introduced into a compounding process, in which the biodegradable polymer material may be mixed with plasticizer, and optionally one or more other additives (e.g., stabilizers), and formed into a compounded material comprising plasticized biodegradable polymer. Other additives may also be mixed with the polymer and plasticizer. For example, as shown in FIG. 2, the other materials (additives) may include, but are not limited to, stabilizers, physical blowing agent(s), chemical blowing agent(s) (and/or precursors), nucleating agent(s), surface modifying additive(s), pigment(s), filler(s), and/or other additive(s). Other additives may include, for example, surface modifying additives (e.g., slip agents) and/or functional ionic components. In one embodiment or in combination with any other embodiment mentioned herein, the biodegradable polymer may be mixed with one or more components having a glass transition temperature (Tg) of below room temperature (about 20° C.). Additionally, or alternatively, the biodegradable polymer may include one or more other polymers and/or additives that may increase the elasticity and/or melt strength of the composition and/or lower the Tg of the composition. Additional details regarding the polymers and additives that may be included in the composition are provided below. Mixing can be accomplished by any known mixing technique, including, but not limited to, rolling in a cylindrical container, overhead stirring, sigma blade mixing, and tumbling.

The compounding process may include a particulating process. The particulating process may generally comprise mixing the biodegradable polymer material, plasticizer, and other additive(s) to form a mixed composition and forming particulate material from the composition. In particular, the particulating process may include a pelletization process, and the particulate material may comprise a quantity of pellets. The term “compounded CE material” means cellulose ester material formed during the compounding process, which may include a mixture of cellulose ester, plasticizer, and other additives. Further such compounded CE material may be in the form of particulate material or pellets. It should be understood that, as used herein, the phrases “particulating” or “particulating processes” may be the same as, or may at least include, “pelletizing” or “pelletizing processes.” In some embodiments, the particulating process may include pelletizing into a water bath, pelletizing on an air cooled belt, underwater pelletizing, solvent compounding, etc.

In one embodiment or in combination with any other embodiment mentioned herein, the plasticizer and other additive(s) may be mixed with cellulose esters by conventional melt compounding techniques, which involve combining the cellulose ester with plasticizer, and optionally the other additives, in a twin screw extruder with appropriate mixing elements and at appropriate temperatures and pressures to achieve a molten, homogeneously combined, cellulose ester mixture by the time the materials exit the extruder. The molten, compounded, cellulose ester mixture may then be extruded through a die with orifices that are about 2-6 mm in diameter so as to extrude a strand. This strand may then be cooled by water (e.g., via underwater pelletization) or air and cut at regular intervals to provide a uniform and desirable size and shape, referred to as “pellets” or “granules.” Although a process for forming pelletized compounded material is described herein, it will be understood that the compounded material fed to the foam sheet production process can be in any physical shape (e.g., pellets, powders, granules, fibers) in accordance with some embodiments. The term “compounded CE material” means cellulose ester material formed during the compounding process, which may include a mixture of cellulose ester, plasticizer, and other additives. Further such compounded CE material may be in the form of a molten mixture or a particulate material (e.g., pellets, powders, granules, fibers, etc.)

The compounded CE material, which as noted above may comprise pellets of plasticized biodegradable polymer, may then be introduced into a foam sheet production process, as illustrated in FIGS. 1 and 2. The foam sheet production process may include one or more zones/steps for producing a foam sheet or film, which are described in greater detail below. Although an exemplary foam sheet production process is described herein, it should be understood that certain aspects described herein may also be applicable to rigid (i.e., non-foamed) materials and articles. As shown in FIG. 1, in one embodiment or in combination with any other embodiment mentioned herein, various additives may be introduced to one or more zones of the foam sheet production process. The additives may include, but are not limited to, stabilizers, physical blowing agent(s), chemical blowing agent(s) (and/or precursors), nucleating agent(s), surface modifying additive(s), pigment(s), filler(s), and/or other additive(s).

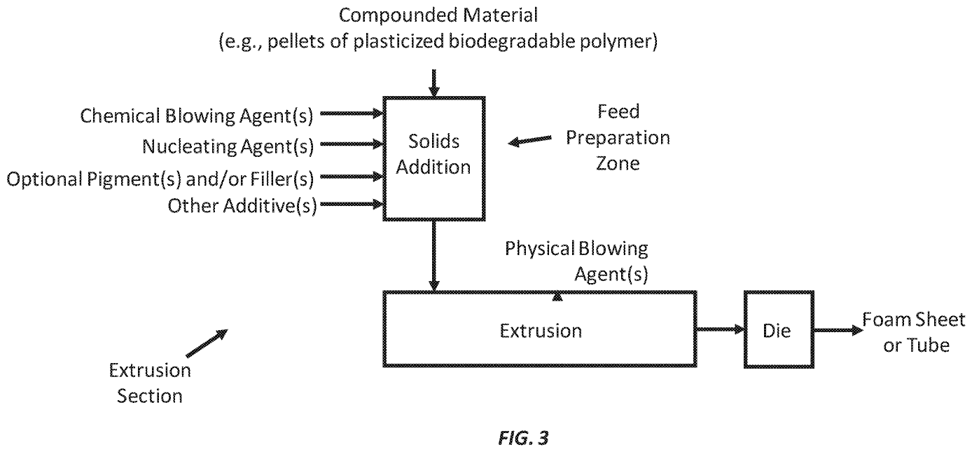

The foam sheet production process may generally include an extrusion section and a sheet forming section. An exemplary extrusion section is depicted in FIG. 3. As shown, the extrusion section may comprise a feed preparation zone, in which solid additives may be combined with the compounded CE material and introduced to the downstream extrusion zone. In one embodiment or in combination with any other embodiment mentioned herein, the feed preparation zone may comprise a feed hopper. Thus, the compounded CE material and the other solid additives may be deposited into the feed hopper, which directs the combined feed composition into the extrusion zone. The feed preparation zone may further comprise a mixer, in which the compounded CE material and one or more additive(s) may be mixed before being introduced to the hopper. Mixing can be accomplished by any known mixing technique, including, but not limited to, rolling in a cylindrical container, overhead stirring, sigma blade mixing, and tumbling. Exemplary solid additive(s) that can be combined with the compounded material may include chemical blowing agent(s), nucleating agent(s), surface modifying additive(s), pigment(s), filler(s), and/or other additive(s).

The combined feed composition from the feed preparation zone may then be introduction to the extrusion zone. The extrusion zone may generally comprise one or more extruders, which may include single screw and/or twin screw extruders. Within the extruder(s), the feed composition may be introduced into an extruder barrel and conveyed, via the screw(s), through a die, which forms an extrudate from the feed composition. The composition may be heated, and at least partially melted, as it is conveyed through the extruder barrel toward the die. Thus, the term “CE melt composition” is used herein to mean the cellulose ester-based feed composition that has been melted into a flowable, molten resin via the extrusion section. Heating may be supplied by external heaters positioned along the outside of the extruder barrel. The shape of the extrudate will generally depend on the shape and size of the die head. The extrudate may be further shaped by downstream processes, as described below.

One or more additive(s) may be introduced to the CE melt composition while in the extruder. For example, one or more physical blowing agent(s) may be added to the CE melt composition by injecting the physical blowing agent into the composition being conveyed within the extruder barrel.

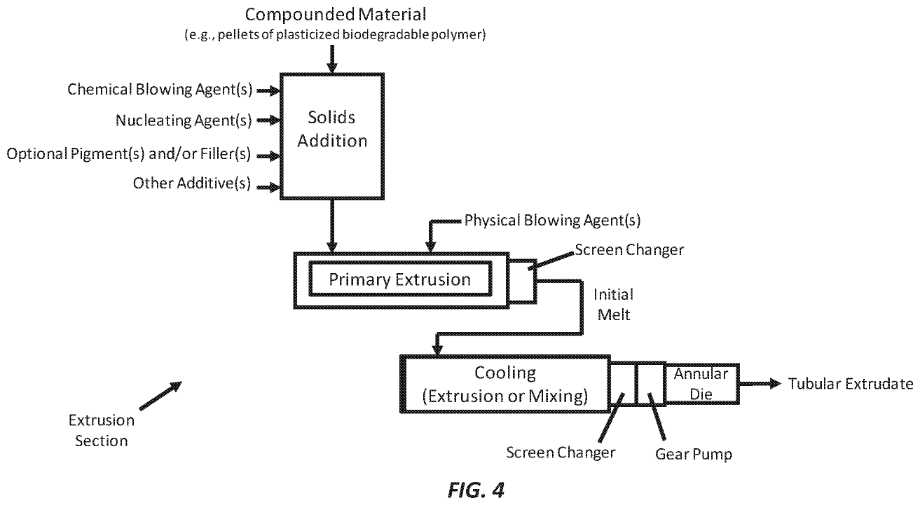

As depicted in FIG. 4, in one embodiment or in combination with any other embodiment mentioned herein, the extrusion zone may comprise a primary extrusion vessel and a cooling vessel. The primary extrusion vessel and cooling vessel may be separate devices or combined as a unitary apparatus. Regardless, the feed composition from the feed preparation zone is introduced into the primary extrusion vessel and at least partially melted as it is conveyed through the extruder barrel, as described above, to thereby produce the CE melt composition. The CE melt composition exiting the primary extrusion vessel may have a temperature from about 220° C. to about 240° C. One or more additives, such as blowing agent(s), may be added to the CE melt composition as it is conveyed through the primary extrusion vessel.

The CE melt composition from the primary extrusion vessel is then introduced into the cooling vessel. The cooling vessel may be a secondary extrusion vessel, which operates similarly to, but at a lower temperature than, the primary extrusion vessel. Within the cooling vessel, the CE melt composition may be further mixed to provide a substantially homogenous mixture of the melted polymer and other additive(s). The CE melt composition may then be directed through the die and out of the die head to provide a cellulose ester-based extrudate, which may be further processed in the sheet forming section of the foam sheet production process. In one embodiment or in combination with any other embodiment mentioned herein, the CE melt composition exiting the die head may have a temperature of at least 150° C., at least 160° C., at least 170° C., at least 180° C., at least 190° C., at least 200° C., from about 150° C. to about 220° C., and/or from about 170° C. to about 200° C.

As shown in FIG. 4, one or more filtration devices may be installed within the extrusion section to filter and remove particulate matter from the CE melt composition. For example, screen changer filtration devices may be installed at the downstream end of the primary and secondary extrusion vessels, which may remove solid components from the CE melt composition before directing the CE melt compositions through the die head to the sheet forming section.

The sheet forming section may include any of a variety of systems and processes for shaping the extrudate into sheets of cellulose ester material that may be used in article formation. The shape of the extrudate will generally depend on the shape of the die head, while the shape of the sheets formed in the sheet forming section can depend on the shape of the die head and other downstream processes. For example, the extrudate may have a generally flat shape, or it may be annular and subjected to further processing to form a flat sheet. In embodiments in which the die has an annular shape, the die may have a diameter from 1 to 40 cm, from 2 to 20 cm, 2 to 10 cm, and/or 3 to 8 cm. Furthermore, the thickness of the opening from which extrudate is ejected, which is referred to herein as a “die gap,” may generally be sized from 0.1 to 6.0 mm, from 0.1 to 3.0 mm, and/or from 0.1 to 1.0 mm.

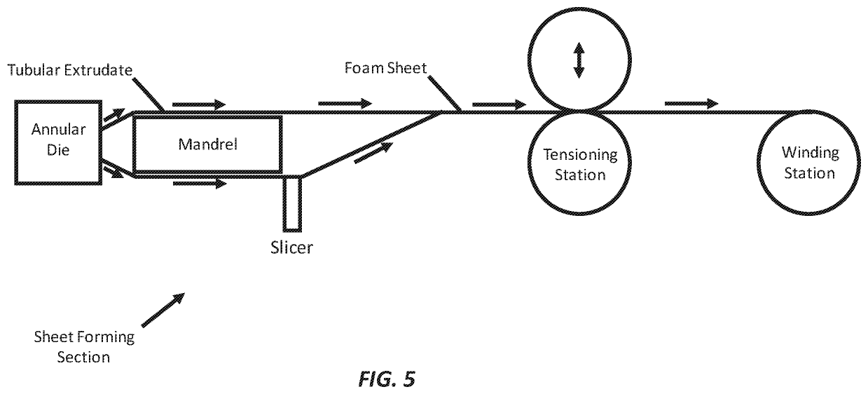

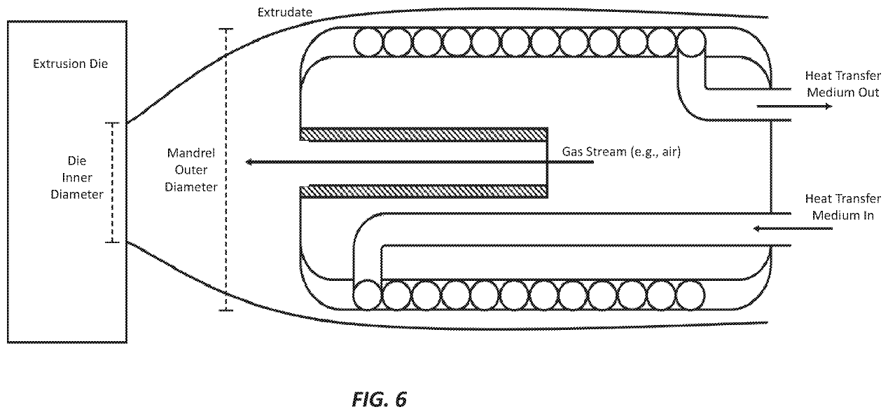

An exemplary sheet forming section is depicted in FIG. 5. As shown, the CE melt composition is extruded through an annular die and drawn over a forming mandrel. A cooling fluid (e.g., air) may be flowed across the interior and/or exterior of the extrudate to cool the extrudate material as it passes over the mandrel. For example, the cooling fluid may be blown from the mandrel toward the die to cool the interior surface of the extrudate between the die and mandrel. Additionally or alternatively, the cooling fluid may be flowed across the mandrel to cool the exterior surface of the extrudate as it passes over the mandrel. In some embodiments, the tubular extrudate is cooled by a cooling ring positioned encircling the mandrel. In certain embodiments, the cooling ring is positioned at a distance of at least 1 foot, at least 2 feet, or at least 3 feet from the annular die. A heating gaseous (vapor) stream (e.g., air) may be fed through an interior portion of the mandrel, for example, to ensure the extrudate remains sufficiently inflated so that the extrudate can be continuously drawn over the mandrel, as depicted in FIG. 6. In some embodiments, the heating vapor stream may comprise air, nitrogen, or carbon dioxide, although other gaseous components may also be used.

Temperature control of the extrudate being drawn over the mandrel can have important effects on the size limitations of the extrudate and the properties of the resulting foams. In one embodiment or in combination with any other embodiment mentioned herein, the temperature of the extrudate material may be maintained at a temperature above the glass transition temperature of the extrudate material in the region between the extruder die and the mandrel. In some embodiments, the CE melt composition has a glass transition temperature (Tg) and is extruded through an annular die at a temperature of at least 40° C., at least 60° C., at least 70° C., at least 80° C., at least 90° C., or at least 100° C. above the Tg of the CE melt composition. In some embodiments, the heating vapor stream may be introduced into the space between the annular die and the forming mandrel at a temperature of 30° C. to 150° C., or 60° C. to 120° C. In some embodiments, the heating vapor stream has a relative humidity (RH) of at least 10%, at least 20%, at least 30%, at least 40%, or at least 50%. In some such embodiments, the heating vapor stream may be used to add moisture to the extrudate in that the water vapor in the gas stream contacts the extrudate as it leaves the die and is drawn over the forming mandrel.

In one embodiment or in combination with any other embodiment mentioned herein, the extrudate is drawn over an exterior surface of the forming mandrel that is maintained at a temperature of greater than 30° C. The surface may be maintained at a temperature of at least 40° C., at least 50° C., or at least 60° C. In some embodiments, the temperature may be controlled by providing heat from one or more electrical heating elements at least partially positioned adjacent the surface. For example, one or more heating elements and/or one or more insulation elements may be positioned at least partially around the space between the annular die and/or the forming mandrel. In some embodiments, the one or more heating elements comprises an infrared (IR) heater. Additionally, or alternatively, the temperature may be controlled by flowing a heat transfer medium (heat transfer fluid) through a conduit at least partially positioned adjacent the surface so as to provide indirect heat transfer between the heat transfer medium and the surface.

FIG. 6 shows an exemplary forming mandrel comprising a heat transfer conduit adjacent the surface of the mandrel. In operation, the heat transfer medium may be introduced into the conduit and flowed through the conduit encircling an interior side of the mandrel surface. The temperature of the heat transfer medium introduced into the conduit may be adjusted as needed so as to maintain the desired surface temperature of the mandrel. Exemplary heat transfer fluids may comprise air, water, oils, glycol, and mixtures thereof, although it will be understood that other suitable heat transfer fluids may also be used.

The composition and temperature of the extrudate material can affect the blow up ratio (BUR) of the extrudate material being drawn over the forming mandrel. As used herein, the term “blow up ratio” means the ratio of the inner diameter of the extruder die to the outer diameter of the outer mandrel. In one embodiment or in combination with any other embodiment mentioned herein, the extrudate is drawn over the forming mandrel at a blow up ratio of 2.0 to 4.0, 2.1 to 3.9, 2.2 to 3.8, 2.3 to 3.7, 2.4 to 3.6, 2.5 to 3.5, although even higher blow up ratios may be achieved in some embodiments. Thus, in some embodiments, the annular die has a die inner diameter (X), and the extrudate is drawn over a forming mandrel having a mandrel outer diameter of at least 3.3X, at least 3.4X, at least 3.5X, at least 3.6X, at least 3.7X, at least 3.8X, at least 3.9X, or at least 4.0X. In some embodiments, the extrudate is drawn over a forming mandrel having a mandrel outer diameter of at least 2.0X, at least 2.1X, at least 2.2X, at least 2.3X, at least 2.4X, or at least 2.5X and/or not more than 4.0X, not more than 3.9X, not more than 3.8X, not more than 3.7X, not more than 3.6X, or not more than 2.5X.

The particular cellulose ester(s) and other polymers and/or additives in the CE melt composition can have an effect on the maximum limit for the BUR without rupturing the extrudate material. This limit can be affected by the inherent stretch ratio and/or melt strength of the composition. In some embodiments, the CE composition comprises cellulose acetate, which in some embodiments may have an optimal BUR of 2.1 to 3.9. In some embodiments, one or more polymers that are miscible or dispersible in cellulose acetate may be included to increase the BUR maximum limit of the material. In some such embodiments, the miscible or dispersible polymers are selected from polyethylene succinate (PES), poly(glycolic acid) (PGA), and starches (including modified starches). In some embodiments, the CE compositions may comprise biodegradable aliphatic polyesters and mixed esters that allow for even higher BURs without rupturing the extrudate material. For example, CE compositions comprising cellulose acetate propionate (CAP), polylactic acid (PLA), and/or polybutylene succinate (PBS) may be capable of achieving BURs of 4.0 or higher. Other polymer blends may also be capable of achieving similar BURs. Other additives, such as chemical blowing agents, physical blowing agents, co-blowing agents, surface modifying additives, elastic polymers (e.g., PEG), and melt strength enhancers (e.g., ionic functional components), may also be included which increase the potential maximum limit for the BUR of the CE compositions. The polymers and additives in the CE compositions are described in greater detail below.

In one embodiment or in combination with any other embodiment mentioned herein, the forming mandrel is tapered such that a first end proximal to the annular die has a first diameter and a second end distal to the annular die has a second diameter. In some embodiments, the first diameter is less than the second diameter, such that the extrudate expands to a higher BUR as it is drawn over the forming mandrel from the first end to the second end. For example, the first end has a first diameter (Y), and the second end has a second diameter of at least 1.1 Y, at least 1.2Y, at least 1.3Y, at least 1.4Y, at least 1.5Y, at least 1.6Y, at least 1.7Y, at least 1.8Y, at least 1.9Y, or at least 2.0Y. In some embodiments, the first end has a first diameter (Y), and the second end has a second diameter of 1.1Y to 3.0Y, 1.2Y to 2.8Y, 1.3Y to 2.6Y, 1 0.4Y to 2.4Y, 1.5Y to 2.2Y, or 1.6Y to 2.0Y. The particular ratio of the tapered mandrel diameters may depend on a variety of factors, such as mandrel length and composition of the extrudate. In some embodiments, the second end has a diameter of at least 3.3X, at least 3.4X, at least 3.5X, at least 3.6X, at least 3.7X, at least 3.8X, at least 3.9X, or at least 4.0X (i.e., the ratio of the second end diameter to the inner die diameter (X)). In some embodiments, the second end has a diameter of 2.0X to 4.0X, 2.1X to 3.9X, 2.2X to 3.8X, 2.3X to 3.7X.

The length of the forming mandrel will generally depend on the elasticity of the extrudate, which is dependent on several factors such as composition, temperature, etc., as described herein. In particular, the selected blow agent(s) can have a significant impact on the appropriate length of the forming mandrel. For example, compositions including CO2 as a blowing agent may require shorter forming mandrels than compositions including larger hydrocarbon blowing agents. Without being bound by any theory, it is believed that the internal pressure from the blowing agent keeps the extrudate from shrinking in the transverse direction. Since CO2 diffuses from the extrudate faster than hydrocarbons (e.g., pentane), the extrudate would freeze off (shrink) if drawn over longer length mandrels. In one embodiment or in combination with any other embodiment mentioned herein, the forming mandrel has a length of 2 feet to 30 feet, 3 feet to 20 feet, 4 feet to 15 feet, or 5 feet to 10 feet. In some embodiments, and particularly when CO2 is included as a blowing agent, the forming mandrel may have a length of 2 feet to 5 feet.

The forming mandrel may be made of a variety of materials and its parts may be made of same or different materials. However, the material(s) used in the outer surface of the forming mandrel (i.e., the surface over which the extrudate is drawn) may have important process consequences. For example, the material(s) of the surface may be selected so as to avoid corrosion, pitting, etching, etc. by certain components in the extrudate composition, such as acids (e.g., acetic acid), provide for desired heat transfer properties, and/or have desirable coefficients of friction with the extrudate compositions. In some embodiments, the surface may comprise aluminum and/or stainless steel. In some embodiments, the surface may comprise a protective coating. Exemplary protective coatings can include carbon coatings, Teflon coatings, and chrome coatings. Notably, chrome coatings are traditionally avoided in forming mandrels due to reactions with the styrene in traditional foam sheeting compositions. However, since the compositions described herein are generally cellulose ester compositions (rather than polystyrene), such reactions are not a concern. Additionally, or alternatively, materials and coatings that provide a generally smooth surface (as opposed to matted surface) may be preferred so as to enable easier drawing of the extrudate over the mandrel without rupturing the material.

Referring again to FIG. 5, a slicer (or slitting device) may be used to open the tubular extrudate, which allows the tubular shape to be formed into a flat sheet. For example, the tubular extrudate passing over the mandrel may be slit and drawn to a tensioning station comprising one or more rollers that flatten the extrudate and maintain a necessary amount of tension on the extrudate to continue pulling the extrudate over the mandrel. The flattened extrudate will generally be in the form of a sheet, which may then be directed to a winding station where the material may be rolled for packaging and transportation.

Referring again to FIG. 1 and FIG. 2, the sheets produced by the sheet production process may be used to form foam articles, which are described in greater detail below. Such articles are particularly useful in the food service industry. Exemplary articles include meat trays. The articles may have one or more particularly advantageous properties. For example, the articles may be biodegradable and/or compostable, and/or the articles may have superior mechanical properties (e.g., strength, density, cell size, absorption, etc.).

In one embodiment or in combination with any other embodiment mentioned herein, the line rate ratio is from 0.1 to 0.33 kg/m, or from 0.1 to 0.3 kg/m, or from 0.1 to 0.29 kg/m, or from 0.1 to 0.28 kg/m, or from 0.1 to 0.27 kg/m, or from 0.1 to 0.25 kg/m, or from 0.1 to 0.23 kg/m, or from 0.1 to 0.22 kg/m, or from 0.1 to 0.21 kg/m, or from 0.1 to 0.19 kg/m or from 0.1 to 0.17 kg/m, or from 0.1 to 0.15 kg/m or from 0.1 to 0.14 kg/m, or from 0.12 to 0.33 kg/m, or from 0.12 to 0.3 kg/m, or from 0.12 to 0.29 kg/m, or from 0.12 to 0.28 kg/m, or from 0.12 to 0.27 kg/m, or from 0.12 to 0.25 kg/m, or from 0.12 to 0.23 kg/m, or from 0.12 to 0.21 kg/m, or from 0.12 to 0.19 kg/m or from 0.12 to 0.17 kg/m, or from 0.12 to 0.15 kg/m or from 0.12 to 0.14 kg/m, or from 0.14 to 0.33 kg/m, or from 0.14 to 0.3 kg/m, or from 0.14 to 0.29 kg/m, or from 0.14 to 0.28 kg/m, or from 0.14 to 0.27 kg/m, or from 0.14 to 0.25 kg/m, or from 0.14 to 0.23 kg/m, or from 0.14 to 0.21 kg/m, or from 0.14 to 0.19 kg/m or from 0.14 to 0.17 kg/m, from 0.16 to 0.33 kg/m, or from 0.16 to 0.3 kg/m, or from 0.16 to 0.29 kg/m, or from 0.16 to 0.28 kg/m, or from 0.16 to 0.27 kg/m, or from 0.16 to 0.25 kg/m, or from 0.16 to 0.23 kg/m, or from 0.16 to 0.21 kg/m, or from 0.16 to 0.19 kg/m. from 0.18 to 0.33 kg/m, or from 0.18 to 0.3 kg/m, or from 0.18 to 0.29 kg/m, or from 0.18 to 0.28 kg/m, or from 0.18 to 0.27 kg/m, or from 0.18 to 0.25 kg/m, or from 0.18 to 0.23 kg/m, or from 0.18 to 0.21 kg/m, from 0.19 to 0.33 kg/m, or from 0.19 to 0.3 kg/m, or from 0.19 to 0.29 kg/m, or from 0.19 to 0.28 kg/m, or from 0.19 to 0.27 kg/m, or from 0.19 to 0.25 kg/m, or from 0.19 to 0.23 kg/m.

### Compositions

The processes described above may comprise the preparation and extrusion of compositions that may be used for downstream processing to form useful articles. For example, in one embodiment or in combination with any other embodiment mentioned herein, the extrusion feed material may comprise a particulate material comprising a biodegradable polymer and optionally one or more additive(s), such as those described herein. In one embodiment or in combination with any other embodiment mentioned herein, the feed material may be combined with one or more additive(s), such as those described herein, to provide a mixed composition comprising the biodegradable polymer and the one or more additive(s). In one embodiment or in combination with any other embodiment mentioned herein, the biodegradable polymer comprises a cellulose ester.

In one embodiment or in combination with any other embodiment mentioned herein, the cellulose ester composition comprises one or more polymers and/or other additives operable to enhance the melt strength of the composition and/or increase the elasticity of the composition. Such polymers and other additives can allow the melt compositions being drawn over the forming mandrel to have increased blow up ratios without rupturing the extrudate as compared to compositions without these polymers and/or additives. For example, in some embodiments, the compositions comprise 1% to 50%, or 2% to 20% by weight of the one or more such polymers and/or other additives. In some embodiments, the composition comprises at least one additive having a specific heat capacity of at least 1800 J/kg-C, or at least 2000 J/kg-C. In some embodiments, the composition comprises one or more additives selected from chemical blowing agents, physical blowing agents (e.g., hydrocarbon blowing agents), surface modifying additives (e.g., slip agents), biodegradable polymers (such as polyethylene glycol (PEG) and others described herein), and/or melt strength enhancers (such as functional ionic components).

Additional details of the composition components, including biodegradable polymers (e.g., cellulose esters) and other additives, are provided below.

### Cellulose Ester

The cellulose esters utilized as described herein can be any that is known in the art. Cellulose ester that can be used for embodiments herein generally comprise repeating units of the structure:

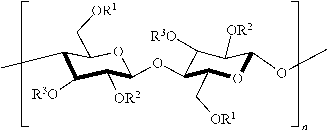

wherein R¹, R², and R³ are selected independently from the group consisting of hydrogen acetyl, propyl or butyl. The substitution level of the cellulose ester is usually expressed in terms of degree of substitution (DS), which is the average number of non-OH substituents per anhydroglucose unit (AGU). Generally, conventional cellulose contains three hydroxyl groups in each AGU unit that can be substituted; therefore, DS can have a value between zero and three. Native cellulose is a large polysaccharide with a degree of polymerization from 250-5,000 even after pulping and purification, and thus the assumption that the maximum DS is 3.0 is approximately correct. Because DS is a statistical mean value, a value of 1 does not assure that every AGU has a single substituent. In some cases, there can be unsubstituted anhydroglucose units, some with two and some with three substituents, and typically the value will be a non-integer. Total DS is defined as the average number of all of substituents per anhydroglucose unit. The degree of substitution per AGU can also refer to a particular substitutent, such as, for example, hydroxyl or acetyl. In one embodiment or in combination with any other embodiment, n is an integer in a range from 25 to 250, or 25 to 200, or 25 to 150, or 25 to 100, or 25 to 75.

In one embodiment or in combination with any other embodiment, the cellulose esters have at least 2 anhydroglucose rings and can have between at least 50 and up to 5,000 anhydroglucose rings, or at least 50 and less than 150 anhydroglucose rings. The number of anhydroglucose units per molecule is defined as the degree of polymerization (DP) of the cellulose ester. In one embodiment or in combination with any other embodiment, cellulose esters can have an inherent viscosity (IV) of about 0.2 to about 3.0 deciliters/gram, or about 0.5 to about 1.8, or about 1 to about 1.5, as measured at a temperature of 25° C. for a 0.25 gram sample in 100 ml of a 60/40 by weight solution of phenol/tetrachloroethane. In one embodiment or in combination with any other embodiment, cellulose esters useful herein can have a DS/AGU of about 1 to about 3.0, or of about 2.0 to about 2.9, or of about 2.2 to about 2.8, or 1 to less than 2.2, or 1 to less than 1.5, and the substituting ester is acetyl.

Cellulose esters can be produced by any method known in the art. Examples of processes for producing cellulose esters are taught in Kirk-Othmer, Encyclopedia of Chemical Technology, 5th Edition, Vol. 5, Wiley-Interscience, New York (2004), pp. 394-444. Cellulose, the starting material for producing cellulose esters, can be obtained in different grades and sources such as from cotton linters, softwood pulp, hardwood pulp, corn fiber and other agricultural sources, and bacterial cellulose, among others.

One method of producing cellulose esters is esterification of the cellulose by mixing cellulose with the appropriate organic acids, acid anhydrides, and catalysts. Cellulose is then converted to a cellulose triester. Ester hydrolysis is then performed by adding a water-acid mixture to the cellulose triester, which can then be filtered to remove any gel particles or fibers. Water is then added to the mixture to precipitate the cellulose ester. The cellulose ester can then be washed with water to remove reaction by-products followed by dewatering and drying.

The cellulose triesters to be hydrolyzed can have three acetyl substituents. These cellulose esters can be prepared by a number of methods known to those skilled in the art. For example, cellulose esters can be prepared by heterogeneous acylation of cellulose in a mixture of carboxylic acid and anhydride in the presence of a catalyst such as H₂SO₄. Cellulose triesters can also be prepared by the homogeneous acylation of cellulose dissolved in an appropriate solvent such as LiCl/DMAc or LiCl/NMP.

Those skilled in the art will understand that the commercial term of cellulose triesters also encompasses cellulose esters that are not completely substituted with acyl groups. For example, cellulose triacetate commercially available from Eastman Chemical Company, Kingsport, TN, U.S.A., typically has a DS from about 2.85 to about 2.99.

After esterification of the cellulose to the triester, part of the acyl substituents can be removed by hydrolysis or by alcoholysis to give a secondary cellulose ester. As noted previously, depending on the particular method employed, the distribution of the acyl substituents can be random or non-random. Secondary cellulose esters can also be prepared directly with no hydrolysis by using a limiting amount of acylating reagent. This process is particularly useful when the reaction is conducted in a solvent that will dissolve cellulose. All of these methods yield cellulose esters that are useful in this invention.

In one embodiment or in combination with any of the mentioned embodiments, the cellulose acetates are cellulose diacetates that have a polystyrene equivalent number average molecular weight (Mn) from about 10,000 to about 100,000 as measured by gel permeation chromatography (GPC) using NMP as solvent and polystyrene equivalent Mn according to ASTM D6474. In one embodiment or in combination with any other embodiment, the cellulose acetate composition comprises cellulose diacetate having a polystyrene equivalent number average molecular weights (Mn) from 10,000 to 90,000; or 10,000 to 80,000; or 10,000 to 70,000; or 10,000 to 60,000; or 10,000 to less than 60,000; or 10,000 to less than 55,000; or 10,000 to 50,000; or 10,000 to less than 50,000; or 10,000 to less than 45,000; or 10,000 to 40,000; or 10,000 to 30,000; or 20,000 to less than 60,000; or 20,000 to less than 55,000; or 20,000 to 50,000; or 20,000 to less than 50,000; or 20,000 to less than 45,000; or 20,000 to 40,000; or 20,000 to 35,000; or 20,000 to 30,000; or 30,000 to less than 60,000; or 30,000 to less than 55,000; or 30,000 to 50,000; or 30,000 to less than 50,000; or 30,000 to less than 45,000; or 30,000 to 40,000; or 30,000 to 35,000; as measured by gel permeation chromatography (GPC) using NMP as solvent and according to ASTM D6474.

The most common commercial secondary cellulose esters are prepared by initial acid catalyzed heterogeneous acylation of cellulose to form the cellulose triester. After a homogeneous solution in the corresponding carboxylic acid of the cellulose triester is obtained, the cellulose triester is then subjected to hydrolysis until the desired degree of substitution is obtained. After isolation, a random secondary cellulose ester is obtained. That is, the relative degree of substitution (RDS) at each hydroxyl is roughly equal.

The cellulose esters useful in the present invention can be prepared using techniques known in the art, and can be chosen from various types of cellulose esters, such as for example the cellulose esters that can be obtained from Eastman Chemical Company, Kingsport, TN, U.S.A., e.g., Eastman™ Cellulose Acetate CA 398-30 and Eastman™ Cellulose Acetate CA 398-10, Eastman™ CAP 485-20 cellulose acetate propionate; Eastman™ CAB 381-2 cellulose acetate butyrate.

In one embodiment or in combination with any other embodiment, the cellulose ester can be prepared by converting cellulose to a cellulose ester with reactants that are obtained from recycled materials, e.g., a recycled plastic content syngas source. In one embodiment or in combination with any other embodiment, such reactants can be cellulose reactants that include organic acids and/or acid anhydrides used in the esterification or acylation reactions of the cellulose, e.g., as discussed herein.

In one embodiment or in combination with any of the mentioned embodiments, or in combination with any of the mentioned embodiments, of the invention, a cellulose ester composition comprising at least one recycle cellulose ester is provided, wherein the cellulose ester has at least one substituent on an anhydroglucose unit (AU) derived from recycled content material, e.g., recycled plastic content syngas.

In one embodiment or in combination with any other embodiment, the cellulose ester composition comprises cellulose ester in an amount from 50 to 99 wt %, or 60 to 99 wt %, or 70 to 99 wt %, or 80 to 99 wt %, from 50 to 98 wt %, or 60 to 98 wt %, or 70 to 98 wt %, or 80 to 98 wt %, or 90 to 98 wt %, 50 to 90 wt %, or 60 to 90 wt %, or 70 to 90 wt %, or 80 to 90 wt %, or 90 to 99 wt %, or 50 to 80 wt %, or 60 to 80 wt %, or 70 to 80 wt %, or 50 to 70 wt %, or 60 to 70 wt %, or 50 to 60 wt %, all based on the total weight of the cellulose ester composition. In some embodiments, the cellulose ester used herein may comprise a combination, blend, or mixture of two or more different types of cellulose esters. For example, in some embodiments, the cellulose esters used herein may be comprised of a blend of two or cellulose esters having differing DSACs; however, the blend may have an total DSAC of between 2.2 and 2.8 or of between 2.0 and 2.9.

### Plasticizer

In one embodiment or in combination with any other embodiment, the cellulose ester compositions described herein can comprise at least one plasticizer. The plasticizer reduces the melt temperature, i.e., the Tg, and/or the melt viscosity of the cellulose ester. Plasticizers for cellulose esters may include glycerol triacetate (Triacetin), glycerol diacetate (Diacetin), dibutyl terephthalate, dimethyl phthalate, diethyl phthalate, poly(ethylene glycol) MW 200-600, dibutyl tartrate, di-2-methoxyethyl phthalate, ethyl o-benzoylbenzoate, triethylene glycol dipropionate, 1,2-epoxypropylphenyl ethylene glycol, 1,2-epoxypropyl(m-cresyl) ethylene glycol, 1,2-epoxypropyl(o-cresyl) ethylene glycol, β-oxyethyl cyclohexenecarboxylate, bis(cyclohexanate) diethylene glycol, triethyl citrate, polyethylene glycol, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate, the benzoate containing plasticizers such as the Benzoflex™ plasticizer series, poly (alkyl succinates) such as poly (butyl succinate), polyethersulfones, o-Cresyl p-toluenesulfonate, n-ethyltoluenesulfonamides, adipate based plasticizers, soybean oil epoxides such as the Paraplex™ plasticizer series, sucrose based plasticizers, dibutyl sebacate, tributyrin, sucrose acetate isobutyrate, the Resolflex™ series of plasticizers, triphenyl phosphate (TPP), triethyl phosphate (TEP), glycolates (e.g., ethyl phthalyl ethyl glycolate “EPEG” and methyl phthalyl ethyl glycolate “MPEG”), methoxy polyethylene glycol, 2,2,4-trimethylpentane-1,3-diyl bis(2-methylpropanoate), and polycaprolactones. In some embodiments, the plasticizer used herein may comprise a combination or mixture of two or more different types of plasticizers.

In one embodiment or in combination with any other embodiment, has a boiling point of at least 100° C., or at least 200° C., and/or not more than 400° C., or not more than 300° C.

In one embodiment or in combination with any other embodiment, the plasticizer is a food-compliant plasticizer. By food-compliant is meant compliant with applicable food additive and/or food contact regulations where the plasticizer is cleared for use or recognized as safe by at least one (national or regional) food safety regulatory agency (or organization), for example listed in the 21 CFR Food Additive Regulations or otherwise Generally Recognized as Safe (GRAS) by the US FDA. In one embodiment or in combination with any other embodiment, the food-compliant plasticizer is triacetin or polyethylene glycol (PEG) having a molecular weight of about 200 to about 600. In one embodiment or in combination with any other embodiment, examples of food-compliant plasticizers that could be considered can include triacetin, triethyl citrate, polyethylene glycol, Benzoflex, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate.

In one embodiment or in combination with any other embodiment, the plasticizer can be present in an amount sufficient to permit the cellulose ester composition to be melt processed (or thermally formed) into useful articles, e.g., single use plastic articles, in conventional melt processing equipment. In one embodiment or in combination with any other embodiment, the plasticizer is present in an amount from 1 to 40 wt % for most thermoplastics processing; or 5 to 25 wt %, or 10 to 25 wt %, or 12 to 20 wt % based on the weight of the cellulose ester composition. In one embodiment or in combination with any other embodiment, profile extrusion, sheet extrusion, thermoforming, and injection molding can be accomplished with plasticizer levels in the 10-30, or 12-25, or 15-20, or 10-25 wt % range, based on the weight of the cellulose ester composition.

In one embodiment or in combination with any other embodiment, the plasticizer is a biodegradable plasticizer. Some examples of biodegradable plasticizers include triacetin, triethyl citrate, acetyl triethyl citrate, polyethylene glycol, the benzoate containing plasticizers such as the Benzoflex™ plasticizer series, poly (alkyl succinates) such as poly (butyl succinate), polyethersulfones, adipate based plasticizers, soybean oil epoxides such as the Paraplex™ plasticizer series, sucrose based plasticizers, dibutyl sebacate, tributyrin, the Resoflex™ series of plasticizers, triphenyl phosphate, glycolates, polyethylene glycol, 2,2,4-trimethylpentane-1,3-diyl bis(2-methylpropanoate), and polycaprolactones.

In one embodiment or in combination with any other embodiment, the cellulose ester composition can contain a plasticizer selected from the group consisting of PEG and MPEG (methoxy PEG). The polyethylene glycol or a methoxy polyethylene glycol composition having an average molecular weight of from 200 Daltons to 600 Daltons, wherein the composition is melt processable, biodegradable, and disintegrable.

In one embodiment or in combination with any other embodiment, the composition comprises polyethylene glycol or methoxy PEG having an average molecular weight of from 300 to 550 Daltons.

In one embodiment or in combination with any other embodiment, the composition comprises polyethylene glycol having an average molecular weight of from 300 to 500 Daltons.

In one embodiment or in combination with any other embodiment, the cellulose ester composition comprises at least one plasticizer (as described herein) in an amount from 1 to 40 wt %, or 5 to 40 wt %, or 10 to 40 wt %, or 12 to 40 wt %, 13 to 40 wt %, or 15 to 40 wt %, or greater than 15 to 40 wt %, or 17 to 40 wt %, or 20 to 40 wt %, or 25 to 40 wt %, or 5 to 35 wt %, or 10 to 35 wt %, or 13 to 35 wt %, or 15 to 35 wt %, or greater than 15 to 35 wt %, or 17 to 35 wt %, or 20 to 35 wt %, or 5 to 30 wt %, or 10 to 30 wt %, or 13 to 30 wt %, or 15 to 30 wt %, or greater than 15 to 30 wt %, or 17 to 30 wt %, or 5 to 25 wt %, or 10 to 25 wt %, or 13 to 25 wt %, or 15 to 25 wt %, or greater than 15 to 25 wt %, or 17 to 25 wt %, or 5 to 20 wt %, or 10 to 20 wt %, or 13 to 20 wt %, or 15 to 20 wt %, or greater than 15 to 20 wt %, or 17 to 20 wt %, or 5 to 17 wt %, or 10 to 17 wt %, or 13 to 17 wt %, or 15 to 17 wt %, or greater than 15 to 17 wt %, or 5 to less than 17 wt %, or 10 to less than 17 wt %, or 13 to less than 17 wt %, or 15 to less than 17 wt %, all based on the total weight of the cellulose ester composition.

In one embodiment or in combination with any other embodiment, the at least one plasticizer includes or is a food-compliant or FDA approved plasticizer. In one embodiment or in combination with any other embodiment, the food-compliant or FDA approved plasticizer includes or is triacetin or PEG MW 300 to 500.

### Biodegradable Polymers

In one embodiment or in combination with any other embodiment, the cellulose ester compositions described herein comprise a biodegradable cellulose ester (BCE) component that comprises at least one BCE, which may include one or more of the cellulose esters described herein, and a biodegradable polymer component that comprises at least one other biodegradable polymer (other than the BCE). In one embodiment or in combination with any other embodiment, the other biodegradable polymer can be chosen from polyhydroxyalkanoates (PHAs and PHBs), polylactic acid (PLA), poly(glycolic acid) (PGA), polycaprolactone polymers (PCL), polybutylene adipate terephthalate (PBAT), polyethylene succinate (PES), polyvinyl acetates (PVAs), polybutylene succinate (PBS) and copolymers (such as polybutylene succinate-co-adipate (PBSA)), cellulose esters, cellulose ethers, starch (including modified starches), proteins, derivatives thereof, and combinations thereof. In one embodiment or in combination with any other embodiment, the cellulose ester composition comprises two or more biodegradable polymers.

In one embodiment or in combination with any other embodiment, the cellulose ester compositions described herein comprise cellulose ester blends with one or more biodegradable polymers that can enhance the melt strength and/or increase the elasticity of the composition. Particularly preferred biodegradable polymers include those that have high biodegradability, low Tg (e.g., below room temperature), and/or low modulus.

In one embodiment or in combination with any other embodiment, the biodegradable polymer is selected from polyethylene succinate (PES), poly(glycolic acid) (PGA), starches (including modified starches), and mixtures thereof. In some such embodiments, these biodegradable polymers can provide increased blow up ratios when combined with cellulose acetate.

In one embodiment or in combination with any other embodiment, the biodegradable polymer is selected from polybutylene succinate (PBS) and copolymers (such as polybutylene succinate-co-adipate (PBSA)), polyhydroxyalkanoates (PHAs and PHBs), polybutylene adipate terephthalate (PBAT), polylactic acid (PLA), starch (including modified starches), and mixtures thereof. In some such embodiments, these biodegradable polymers can provide increased blow up ratios when combined with cellulose acetate propionate (CAP) and/or cellulose acetate butyrate (CAB).

In one embodiment or in combination with any other embodiment, the cellulose ester composition contains a biodegradable polymer (other than the BCE) in an amount from 0.1 to less than 50 wt %, or 1 to 40 wt %, or 1 to 30 wt %, or 1 to 25 wt %, or 1 to 20 wt %, based on the cellulose ester composition. In one embodiment or in combination with any other embodiment, the cellulose ester composition contains a biodegradable polymer (other than the BCE) in an amount from 0.1 to less than 50 wt %, or 1 to 40 wt %, or 1 to 30 wt %, or 1 to 25 wt %, or 1 to 20 wt %, based on the total amount of BCE and biodegradable polymer. In one embodiment or in combination with any other embodiment, the at least one biodegradable polymer comprises a PHA having a weight average molecular weight (Mw) in a range from 10,000 to 1,000,000, or 50,000 to 1,000,000, or 100,000 to 1,000,000, or 250,000 to 1,000,000, or 500,000 to 1,000,000, or 600,000 to 1,000,000, or 600,000 to 900,000, or 700,000 to 800,000, or 10,000 to 500,000, or 10,000 to 250,000, or 10,000 to 100,000, or 10,000 to 50,000, measured using gel permeation chromatography (GPC) with a refractive index detector and polystyrene standards employing a solvent of methylene chloride. In one embodiment or in combination with any other embodiment, the PHA can include a polyhydroxybutyrate-co-hydroxyhexanoate.

### Nucleating Agent

Nucleating agent means a chemical or physical material that provides sites for cells to form in a molten formulation mixture, such as within a CE melt composition. As will be described in more detail below, nucleating agents may be added to compounded CE material during the compounding process. Alternatively, or in addition, nucleating agents may be added during the foam sheet production process. For example, the nucleating agents may be blended with the formulation that is introduced into the hopper of the extruder of the extruding section. Alternatively, the nucleating agents may be added to the CE melt composition in the extruder itself. Nucleating agents may include physical nucleating agents and chemical nucleating agents. Physical nucleating agents are materials that are immiscible with the polymer matrix of the CE melt composition at the extrusion temperature of the extrusion section. Chemical nucleating agents are materials that react (e.g., decompose) during extrusion (e.g., at the extrusion temperature within the extruder) to form physical nucleating agents. Thus, chemical nucleating agents may be considered (and referred to herein as) precursors of in situ formed physical nucleating agents.

Suitable physical nucleating agents will comprise fine particles having desirable particle sizes and/or shapes to create cell nucleation sites within the CE melt composition. For example, in some embodiments, physical nucleating agents will have a mean particle size of less than 1000 microns, less than 500 microns, less than 100 microns, less than 50 microns, less than 25 microns, less than 20 microns, less than 10 microns, less than 5 microns, less than 2 microns, less than 1.5 microns, and/or less than 1.0 microns. However, in some other embodiments, it may be preferred to have nanoscale-sized particles. Furthermore, it some embodiments, physical nucleating agents will preferably have a high aspect ratio (i.e., width:height). For example, in some embodiments, physical nucleating agents will have a mean aspect ratio of greater than 1:1, greater than 2:1, greater than 5:1, greater than 10:1, greater than 20:1, greater than 30:1, greater than 40:1, greater than 50:1, greater than 75:1, and/or greater than 100:1. Furthermore still, as noted above, physical nucleating agents should be immiscible with the polymer matrix of the CE melt composition at the extrusion temperature of the extrusion section. As such, in some embodiments, the physical nucleating agents should have a melting temperature at least 220° C., at least 230° C. of at least 240° C., at least 250° C., at least 275° C., at least 300° C., at least 325° C., or at least 350° C. Nevertheless, the physical nucleating agents may be selected such that they have the ability to, after melting, recrystallize upon cooling.

Examples of suitable inorganic physical nucleating agents include, but are not limited to, minerals such as talc, CaCO₃, mica, and mixtures of at least two of the foregoing. One representative example is Heritage Plastics HT6000 Linear Low Density Polyethylene (LLDPE) Based Talc Concentrate. Other inorganic physical nucleating agents include wollastonite, silica, silicon oxide, titanium oxide, magnesium oxide, aluminum oxide and calcium silicate, barium sulfate, Kaolin, aluminum tryhydrateATH (Al(OH)₃), MDH (Mg(OH)₂), Diatomaceous earth, magnetite/hematite, halloysite, zinc oxide, and titanium dioxide. In some embodiments, the inorganic nucleating agents will comprise oxides, such as metal oxides or mixed metal oxides, such as those selected from one or more of the following: aluminum oxide, antimony oxide, arsenic oxide, bismuth oxide, boron oxide, calcium oxide, gallium oxide, iron oxide, lithium oxide, magnesium oxide, silicon oxide, and titanium oxide. In other embodiments, the inorganic nucleating agents will comprise silicates, such as silicates selected from one or of the following: magnesium silicate and calcium silicate.

It has been discovered that biodegradable natural, particulate materials derived from renewable organic sources (e.g., organic nucleating agents) can also serve as effective physical nucleating agents. Natural materials that can be physical nucleating agents include material comprised of cellulose fibers and/or cellulose starch. Examples include, but are not limited to almond shell flour, animal fiber, apricot shell flour, bamboo flour, tree bark flour, clam shell flour, coconut shell flour, coconut coir, cork flour, corn cob flour, corn cob grit, cottonseed hulls, flock & fiber, hazelnut shell flour, kenaf flour, natural fibers, nutshell hull & flour, oat fiber powder, olive stone flour, peanut hulls flour, pecan shell flour, pine-nut shell powder, pistachio-nut shell flour, plant fiber, rice hull flour, rice hull grit, rice husk, soy bean flour, starch flour (hydrophobic), walnut shell flour, wheat chaff, wheat husk, and wood flour. Other organic physical nucleating agents include cellulose powder, chitin, chitosan, stearic acid metal salts, carbon black, and dolomite.

As noted above, suitable chemical nucleating agents (or precursors of in situ formed physical nucleating agents) are configured to decompose to create cell nucleation sites in the CE melt composition when a threshold chemical reaction temperature is reached. These small cells act as nucleation sites for larger cell growth from a physical or other type of blowing agent. In some embodiments, the precursors are configured to form a gas during extrusion of the particulate material, such as CO₂ or N₂.

Examples of chemical nucleating agents include but are not limited to acids, such as citric acid or a citric acid-based material. Other acids may include lauric acid, stearic acid, tartaric acid, ascorbic acid, propionic acid, and hexanoic acid. One representative example is HYDROCEROL™ CF-40E (available from Clariant Corporation), which contains citric acid and a crystal nucleating agent. In some embodiments, the chemical nucleating agents will include a combination of an acid and a base, such as a carbonate, which may include sodium bicarbonate, zinc bicarbonate, potassium bicarbonate, sodium carbonate, potassium carbonate, etc. For instance, a representative example of a chemical nucleating agent is a combination of citric acid and sodium bicarbonate. In some embodiments, chemical nucleating agents may include a carrier within which the active components of the nucleating agents are dispersed. For example, yet another representative example of chemical nucleating agents is a combination of citric acid, sodium bicarbonate, and a carrier. In some embodiments, the carrier may comprise polystyrene. However, the carrier may comprise other compositions, such as various biopolymers (e.g., polybutylene succinate, Capa polyesters, etc.), polyolefins, acrylic copolymers (e.g., ethylene methyl acrylate), or the like. In some such embodiments, the citric acid and sodium bicarbonate may comprise about half (in wt %) of the chemical nucleating agents, while the carrier makes up the remaining half (in wt %). Furthermore, in some of such embodiments, there may be more sodium bicarbonate than citric acid in the chemical nucleating agent. For instance, there may be about three times as much (in wt %) sodium bicarbonate than citric acid in the chemical nucleating agent. It should also be understood that in some embodiments, no carrier may be required or used, such as the case with the nucleating agent being Hecofoam or Hydrocerol.

In one embodiment or in combination with any of the embodiments mentioned herein, the nucleating agents are present at from 0.1 to 10 wt %, from 0.1 to 5.0 wt %, at least 0.1 wt %, at least 0.25 wt %, at least 0.5 wt % at least 1.0 wt %, at least 1.25 wt %, at least 1.5 wt %, at least 1.75 wt %, at least 2.0 wt %, at least 2.25 wt %, at least 2.5 wt %, at least 2.75 wt %, or at least 3.0 wt %, or at least 3.5 wt %, or at least 4.0 wt %, or at least 4.5 wt % and/or less than 7.5 wt %, less than 5 wt %, less than 4 wt %, less than 3 wt %, less than 2 wt %, or less than 1.0 wt %, all based on the total weight of the cellulose ester composition. In some embodiments, the nucleating agents used herein may comprise a combination or mixture of two or more different types of nucleating agents.

It is noted that the cellulose ester material, whether in the form of compounded CE material or CE melt composition, will generally be able to accept a maximum amount of nucleating agent that can function to form nucleation sites. Any remaining nucleating agent that is added to the cellulose ester material will remain as filler. Fillers can provide various properties to the resulting cellulose ester foams and/or articles based on the type of filler used. For example, some fillers can provide increased/decreased density, ductility, Young's modulus, yield strength, heat deflection temperature, permeability, impact resistance, elongation to break, adhesion properties, biodegradation, etc. of the cellulose ester material. Fillers can also be used to alter the visual characteristics (e.g., color, opacity, etc.) and tactile characteristics (e.g., material continuous, surface roughness, etc.) of the cellulose ester material.

### Blowing Agents

A blowing agent refers to a physical or a chemical material (or combination of materials) that acts to expand nucleation sites. Blowing agents may include chemical blowing agents, physical blowing agents, combinations thereof, or several types of chemical and physical blowing agents. The blowing agents function to reduce density of a material by expanding cells formed in the molten formulation at the nucleation sites. The blowing agent may be added to the CE melt composition in the extruder. It has been surprisingly discovered that the hygroscopic nature of biodegradable particulate natural fillers allows them to absorb moisture and carry the absorbed water into the molten resin mixture where the water can act as a physical blowing agent.

Examples of physical blowing agents include H₂O, N₂, CO₂, alkanes, alkenes, ethers, ketones, argon, helium, air or mixtures. In addition, it has been surprisingly discovered that the hygroscopic nature of biodegradable particulate natural fillers allows them to absorb moisture and carry the absorbed water into the molten resin mixture where the water can act as a physical blowing agent. Hygroscopic biodegradable natural fillers can be formulated into a composition and allowed to absorb moisture prior to the foaming process, where the water then is released to act as a physical blowing agent. Beneficially, the water may also be used as a plasticizer for the cellulose ester resin. Furthermore, in some embodiments, physical blowing agents may include hydrocarbons, such as pentane/isopentane or butane/isobutane. Other hydrocarbons may include propane, ethane, methane, hexane, cyclohexane, cyclopentane, cyclobutene, or the like.

Chemical blowing agents are materials that degrade or react to produce a gas (e.g., CO₂ or N₂). Such gasses expand the cells within the molten resin mixture and/or resulting foam mixture to produce a structural material with a plurality of gaseous voids dispersed throughout. Chemical blowing agents may be endothermic or exothermic. Chemical blowing agents typically degrade at a certain temperature to decompose and release gas. Examples of chemical blowing agents include azodicarbonamide, acids (e.g., citric acid), and carbonates, such as sodium bicarbonate, sodium carbonate, ammonium bicarbonate, ammonium carbonate, zinc carbonate, and the like and combinations thereof.

In one embodiment or in combination with any of the embodiments mentioned herein, the blowing agents described above may be combined with a secondary blowing agent (or co-blowing agent). In some embodiments, the co-blowing agent is selected from the group consisting of methyl acetate, ethanol, ketones (e.g., acetone), and mixtures thereof.

In one embodiment or in combination with any of the embodiments mentioned herein, the blowing agent (and any co-blowing agent) is present at from 0.3 to 1.5 wt %, or 0.3 to 2.0 wt %, or 0.3 to 2.5 wt %, or 0.3 to 3.0 wt %, or 0.3 to 3.5 wt %, or 0.3 to 4.0 wt %, or 0.3 to 8%, or 1.3 to 1.5 wt %, or 1.3 to 2.0 wt %, or 1.3 to 2.5 wt %, or 1.3 to 3.0 wt %, or 1.3 to 3.5 wt %, or 1.3 to 4.0 wt %, or 1.3 to 4.5 wt %, or 1.3 to 5.0 wt %, or 1.3 to 5.5 wt %, or 1.5 to 3.0 wt %, or 1.5 to 4.0 wt %, or 1.5 to 5.0 wt %, or 1.5 to 6.0 wt %, or 2.0 to 3.0 wt %, or 2.0 to 4.0 wt %, or 2.0 to 5.0 wt %, or 2.0 to 6.0 wt %, or 2.5 to 3.0 wt %, or 2.5 to 4.0 wt %, or 2.5 to 5.0 wt %, or 2.5 to 6.0 wt %, or 3.0 to 4.0 wt %, or 3.0 to 5.0 wt %, or 3.0 to 6.0 wt %, or 0.0 to 9.0 wt %, or 0.5 to 9.0 wt %, or 1.0 to 9.0 wt %, or 1.5 to 9.0 wt %, or 2.0 to 9.0 wt %, or 2.5 to 9.0 wt %, or 3.0 to 9.0 wt %, or 3.5 to 9.0 wt %, or 4.0 to 9.0 wt %, or 4.5 to 9.0 wt %, or 5.0 to 9.0 wt %, or 5.5 to 9.0 wt %, or 6.0 to 9.0 wt %, or 6.5 to 9.0 wt %, or 7.0 to 9.0 wt %, or 7.5 to 9.0 wt %, or 8.0 to 9.0 wt %, or 8.5 to 9.0 wt %, all based on the total weight of the cellulose ester composition. In some embodiments, the blowing agents used herein may comprise a combination or mixture of two or more different types of blowing agents.

### Surface Modifying Additives

Surface modifying additives refer to materials that can be added to cellulose ester compositions to modify the structure of the compositions (or the resulting foam articles) to improve processing of the cellulose ester compositions. For example, the inventors of the present application have found that adding surface modifying additives to the compounded CE material (e.g., to the pellets during the compounding process) or to the CE melt composition (e.g., during the extrusion process) can improve processing by reducing unwanted sticking of the CE melt composition to the die or mandrel (or to other components of the foam sheet production process). Such reduction in sticking may be achieved by the surface modifying additives inhibiting the fusing of cellulose esters caused by plasticizers. The addition of surface modifying additives may also reduce blocking of the cellulose ester foam sheets produced at the sheet forming section. Furthermore, surface modifying additives may also improve the foam sheet production process by allowing the process to be performed at lower temperatures and/or allowing for increased blow up ratios when drawing the melt compositions over forming mandrels.

Furthermore still, in some embodiments, the surface modifying additives may function as anti-static additives, which inhibit electrical sparks or arcing in the CE melt composition. The inhibition of electrical sparks or arcing can be particularly important when hydrocarbons are used as blowing agents, so as to reduce the chance of igniting the hydrocarbons and causing fires. Beneficially, surface modifying additives may also reduce the diffusion of blowing agents, such as hydrocarbons, out of the foam sheets or resulting articles. In some embodiments, hydrocarbons themselves may be used as surface modifying additives.

Nevertheless, more general examples of surface modifying additives that may be used with compounded CE material (e.g., during the compounding process) or to the CE melt composition (e.g., during the foam sheet production process) according to embodiments of the present invention include fatty acids, such as palmitic acid, tallow acid, stearic acid, oleic acid, linoleic and linolenic acids, arachidic/behenic acids, behenic acid, and erucic acid. Surface modifying additives may also include fatty acid amides, such as erucamides, oleoamides, stearmides, bhenamides, secondary amides, and bisamides.

Additional examples of surface modifying additives may include glycerol esters and/or stearate esters, such as monoglycerides, diglycerides, and triglycerides. The monoglycerides may include glycerol monostearate or monoglyceride derivatives, such as diacetyl tartaric acid esters of mono- and diglycerides (DATEM), ethoxylated monoglyceride, succinyl monoglyceride, and propylene glycol monoesters (PGME). Examples of surface modifying additives may also include metallic stearates such as aluminum stearate, calcium stearate, lithium stearate, magnesium stearate, sodium stearate, zinc stearate, and/or combinations thereof (e.g., Calcium/Zinc stearates). Examples of surface modifying additives may also include waxes, such as polyolefin waxes (polypropylene wax and polyethylene wax), oxidized olefin waxes, ethylene acrylic acid (EAA) copolymer waxes, ethylene methyl acrylate (EMA) copolymer waxes, EAA ionomer axes, acrylic waxes, and/or natural waxes, such as rice bran wax, sunflower wax, sugar cane wax, candelilla wax, soy wax, bees wax, candelilla wax, and carnauba waxes.

Other, non-exclusive examples of surface modifying additives include aliphatic diesters (e.g., dioctyl adipate), polyglycol diesters, alkyl alkylether diesters, aromatic triesters, polyester resins, chlorinated hydrocarbons, halogenated hydrocarbons, alkylether monoesters, and alkyl monoesters. In addition, various oils may be used as surface modifying additives, such as aromatic oils, napthenic oils, glyceride oils, silicon oils, and epoxidized oils (e.g., soybean oil and linseed oil). Thus, in some embodiments, the surface modifying additives comprise plasticizers, such as aliphatic diester plasticizers, polyester plasticizers, and the like. Furthermore, in some embodiments, surface modifying additives may comprise a polyhedral oligomeric silsesquioxane (POSS).

More generally, surface modifying additives used in embodiments of the present invention may have a lower polarity than the cellulose ester in compounded CE material (e.g., during the compounding process) or to the CE melt composition (e.g., during the foam sheet production process). For example, the surface modifying additives may have (based on Hansen solubility parameters): a total solubility parameter δ of less than 25 MPa^{1/2}, less than 20 MPa^{1/2}, or less than 19.5 MPa^{1/2}; a dispersion force solubility parameter δ_{d} of less than 18 MPa^{1/2}, less than 16 MPa^{1/2}, or less than 14 MPa^{1/2}; a dipolar intermolecular force solubility parameter δ_{d} of less than 12 MPa^{1/2}, less than 8 MPa^{1/2}, or less than 4 MPa^{1/2}; and/or a hydrogen bond solubility parameter δₕ of less than 11 MPa^{1/2}, less than 10 MPa^{1/2}, or less than 9 MPa^{1/2}. However, in some other embodiments, the surface modifying additives used in embodiments of the present invention may have a higher polarity than the cellulose ester in compounded CE material (e.g., during the compounding process) or to the CE melt composition (e.g., during the foam sheet production process). For example, the surface modifying additives may have (based on Hansen solubility parameters): a total solubility parameter δ of more than 21.5 MPa^{1/2}, more than 23 MPa^{1/2}, or more than 25 MPa^{1/2}. In addition, in some embodiments, surface modifying additives may have a boiling point greater than 200° C., greater than 220° C., greater than 240° C., greater than 260° C., greater than 280° C., or greater than 300° C. Furthermore, the surface modifying additives may have a molecular weight greater than 100 g/mol, greater than 150 g/mol, greater than 220 g/mol, greater than 260 g/mol, greater than 300 g/mol, or greater than 340 g/mol and/or no more than 1000 g/mol, no more than 2500 g/mol, or no more than 5000 g/mol. Furthermore still, it may be preferable for the surface modifying additives to not be soluble in the plasticizer(s) used in the cellulose ester compositions. For instance, it may be preferable for the surface modifying additives to not be soluble in triacetin. Finally, in some embodiments, the surface modifying additives may be biodegradable and/or food-compliant or FDA approved.

In one embodiment or in combination with any of the embodiments mentioned herein, the surface modifying additives are present at from 0.05 to 0.75 wt %, or 0.05 to 1.0 wt %, or 0.05 to 2.5 wt %, or 0.05 to 5.0 wt %, or 0.75 to 1.0 wt %, or 0.75 to 2.5 wt %, or 0.75 to 5.0 wt %, or 0.1 to 1.0 wt %, or 0.1 to 2.5 wt %, 0.1 to 5.0 wt %, or 1.0 to 2.5 wt %, or 1.0 to 5.0 wt %, or 2.5 to 5.0 wt %, all based on the total weight of the cellulose ester composition. In some embodiments, the surface modifying additives used herein may comprise a combination or mixture of two or more different types of surface modifying additives.

### Melt Strength Enhancers

The elasticity of the cellulose ester compositions, and particularly during heated processes such as extrusion and thermoforming, may be increased by including one or more melt strength enhancers. Such melt strength enhancers may be in the form of functional ionic components. A variety of compounds and materials may be used so long as they include ionic functional groups. For example, in some embodiments, the functional ionic component is selected from the group consisting of acacia gum, sulfopolyesters, quaternary salts, ionomers, ionic liquids, ionic waxes, and mixtures thereof.

### Articles

Extruded sheets of cellulose ester foam may be formed using the extrusion section and/or the sheet forming section described above. Such extruded sheets of comprise a structural material with a plurality of gaseous voids disposed throughout. Such gaseous voids are formed by expansion of the blowing agent in the form of a gas within the cellulose polymer melt. The structural material is cellulose ester based, with specific amounts of the compositional components of the structural material (e.g., cellulose ester, plasticizer, nucleating agents, surface modifying additives, etc.) having been described above in more detail. Articles may be formed from the extruded sheets of foam in accordance with embodiments, and may be particularly useful in the food service industry. Exemplary articles include meat trays. The articles may have one or more particularly advantageous properties. For example, the articles may be biodegradable and/or compostable, and/or the articles may have superior mechanical properties (e.g., strength, density, cell size, absorption, etc.).

In one embodiment or in combination with any of the embodiments mentioned herein, the foam has a density less than 0.20 g/cm³, less than 0.18 g/cm³, less than 0.15 g/cm³, less than 0.12 g/cm³, less than less than 0.10 g/cm³, less than 0.08 g/cm³, less than less than 0.06 g/cm³, or less than less than 0.04 g/cm³, or from 0.04 to 0.8 g/cm³, 0.04 to 0.6 g/cm³, 0.04 to 0.5 g/cm³, 0.04 to 0.4 g/cm³, 0.04 to 0.3 g/cm³, 0.04 to 0.2 g/cm³, 0.04 to 0.15 g/cm³, 0.04 to 0.12 g/cm³, 0.04 to 0.10 g/cm³, 0.04 to 0.08 g/cm³, 0.04 to 0.06 g/cm³, or from 0.05 to 0.8 g/cm³, 0.05 to 0.6 g/cm³, 0.05 to 0.5 g/cm³, 0.05 to 0.4 g/cm³, 0.05 to 0.3 g/cm³, 0.05 to 0.2 g/cm³, 0.05 to 0.15 g/cm³, 0.05 to 0.12 g/cm³, 0.05 to 0.10 g/cm³, 0.05 to 0.08 g/cm³, 0.06 to 0.8 g/cm³, 0.06 to 0.6 g/cm³, 0.06 to 0.5 g/cm³, 0.06 to 0.4 g/cm³, 0.06 to 0.3 g/cm³, 0.06 to 0.2 g/cm³, 0.06 to 0.15 g/cm³, 0.06 to 0.12 g/cm³, 0.06 to 0.10 g/cm³, 0.06 to 0.08 g/cm³, 0.08 to 0.8 g/cm³, 0.08 to 0.6 g/cm³, 0.08 to 0.5 g/cm³, 0.08 to 0.4 g/cm³, 0.08 to 0.3 g/cm³, 0.08 to 0.2 g/cm³, 0.08 to 0.15 g/cm³, 0.08 to 0.12 g/cm³, 0.08 to 0.10 g/cm³, 0.1 to 0.8 g/cm³, 0.1 to 0.6 g/cm³, 0.1 to 0.5 g/cm³, 0.1 to 0.4 g/cm³, 0.1 to 0.3 g/cm³, 0.1 to 0.2 g/cm³, 0.1 to 0.15 g/cm³, 0.1 to 0.12 g/cm³, 0.2 to 0.8 g/cm³, 0.2 to 0.6 g/cm³, 0.2 to 0.5 g/cm³, 0.2 to 0.4 g/cm³, 0.2 to 0.3 g/cm³, 0.3 to 0.6 g/cm³, 0.3 to 0.5 g/cm³, 0.3 to 0.4 g/cm³, 0.4 to 0.6 g/cm³, 0.4 to 0.5 g/cm³, or 0.5 to 0.6 g/cm³.

In one embodiment or in combination with any of the embodiments mentioned herein, the average foam cell size is from 40 μm to 600 μm, or 50 μm to 600 μm, or 60 μm to 600 μm, or 70 μm to 600 μm, or 80 μm to 600 μm, or 90 μm to 600 μm, or 100 μm to 600 μm, or 150 μm to 600 μm, or 200 μm to 600 μm, or 250 μm to 600 μm, or 300 μm to 600 μm, or 400 μm to 600 μm, or 500 μm to 600 μm, or 40 μm to 550 μm, or 40 μm to 500 μm, or 40 μm to 450 μm, or 40 μm to 400 μm, or 40 μm to 350 μm, or 40 μm to 300 μm, or 40 μm to 250 μm, or 40 μm to 200 μm, or 40 μm to 150 μm, or 40 μm to 100 μm.

Further Inventive Concepts Related to Processes and Systems for Producing Pellets, Foam Sheets, and/or Articles.

As described above, embodiments of the present invention processes and systems for the production of biodegradable cellulose ester compositions, sheets, and articles. In particular, the optimal and maximum blow up ratios (BUR) can be achieved and/or increased, thereby maximizing the amount of useable foam sheet material that may be produced in the sheet forming process. The optimal or maximum BUR can be increased by including certain polymers and/or additives that adjust the elasticity, melt strength, and/or glass transition temperature (Tg) of the compositions, and/or by maintaining the composition at an optimal temperature for increasing the elasticity.

The embodiments described herein are particularly useful in the production of cellulose ester foamed sheets and articles, although the embodiments may be utilized in other sheet and article production applications.

In one embodiment or in combination with any of the embodiments mentioned herein, a biodegradable cellulose acetate foam or article may be produced that is industrial compostable or home compostable. In one subclass of this class, the foam or article is industrial compostable. In one sub-subclass of this subclass, the foam or article has a thickness that is less than 6 mm. In one sub-subclass of this subclass, the foam or article has a thickness that is less than 3 mm. In one sub-subclass of this subclass, the article has a thickness that is less than 1.1 mm. In one subclass of this class, the foam or article is home compostable. In one sub-subclass of this subclass, the foam or article has a thickness that is less than 6 mm. In one sub-subclass of this subclass, the foam or article has a thickness that is less than 3 mm. In one sub-subclass of this subclass, the foam or article has a thickness that is less than 1.1 mm. In one sub-subclass of this subclass, the foam or article has a thickness that is less than 0.8 mm. In one sub-subclass of this subclass, the foam or article has a thickness that is less than 0.6 mm. In one sub-subclass of this subclass, the foam or article has a thickness that is less than 0.4 mm.

In one embodiment or in combination with any of the embodiments mentioned herein, the thickness of the foam or article is from 1 to 10 mm, from 1 to 8 mm, from 2 to 8 mm, from 3 to 7 mm, from 4 to 6 mm, about 4 mm, about 5 mm, about 6 mm, about 7 mm, or about 8 mm. However, it should be noted that the foam or article may have other, larger sizes. For example, in some embodiments, the foam or article may have a thickness from 0.5 to 24 inches, from 1 to 15 inches, or 3 to 12 inches. In some embodiments, the foam or article may have a thickness of from 100-400 mils, 120-300 mils, or 150-250 mils.

In one embodiment or in combination with any of the embodiments mentioned herein, the foam or article exhibits greater than 90% disintegration after 12 weeks according to the disintegration test protocol for films, as described in the specification.

The compositions used to prepare the biodegradable cellulose acetate foams can comprise other additives such as fillers, stabilizers, odor modifiers, waxes, compatibilizers, biodegradation promoters, dyes, pigments, colorants, lubricants, anti-oxidants, viscosity modifiers, antifungal agents, heat stabilizers, antibacterial agents, softening agents, mold release agents, UV absorbers, and combinations thereof. Each additional additive may be present in the cellulose ester-based material in an amount less than 10 wt. %, less than 5 wt. % less than 4 wt. %, less than 3 wt. %, less than 2 wt. %, or less than 1.0 wt. %. It should be noted that the same type of compounds or materials can be identified for or included in multiple categories of components in the cellulose acetate compositions. For example, polyethylene glycol (PEG) could function as a plasticizer or as an additive that does not function as a plasticizer, such as a hydrophilic polymer or biodegradation promotor, e.g., where a lower molecular weight PEG has a plasticizing effect and a higher molecular weight PEG functions as a hydrophilic polymer but without plasticizing effect.

In one embodiment or in combination with any other embodiment mentioned herein, the foam, composition or foamable composition further comprises a photodegradation catalyst. In one class of this embodiment, the photodegradation catalyst is a titanium dioxide, or an iron oxide. In one subclass of this class, the photodegradation catalyst is a titanium dioxide. In one subclass of this class, the photodegradation catalyst is an iron oxide.

In one embodiment or in combination with any other embodiment mentioned herein, the foam, composition, or foamable composition further comprises a pigment. In one class of this embodiment, the pigment is a titanium dioxide, a carbon black, or an iron oxide. In one subclass of this class, the pigment is a titanium dioxide. In one subclass of this class, the pigment is a carbon black. In one subclass of this class, the pigment is an iron oxide. In one subclass of this class, the pigment is a biodegradable particulate natural filler.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

To be considered “compostable,” a material must meet the following four criteria: (1) the material should pass biodegradation requirement in a test under controlled composting conditions at elevated temperature (58° C.) according to ISO 14855-1 (2012) which correspond to an absolute 90% biodegradation or a relative 90% to a control polymer, (2) the material tested under aerobic composting condition according to ISO16929 (2013) must reach a 90% disintegration; (3) the test material must fulfill all the requirements on volatile solids, heavy metals and fluorine as stipulated by ASTM D6400 (2012), EN 13432 (2000) and ISO 17088 (2012); and (4) the material should not cause negative on plant growth.

As used herein, the term “biodegradable” generally refers to the biological conversion and consumption of organic molecules. Biodegradability is an intrinsic property of the material itself, and the material can exhibit different degrees of biodegradability, depending on the specific conditions to which it is exposed. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

To be considered “biodegradable,” under home composting conditions according to the French norm NF T 51-800 and the Australian standard AS 5810, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradation under home compositing conditions is 1 year.

To be considered “biodegradable,” under industrial composting conditions according to ASTM D6400 and ISO 17088, at least 90 percent of the organic carbon in the whole item (or for each constituent present in an amount of more than 1% by dry mass) must be converted to carbon dioxide by the end of the test period when compared to the control or in absolute. According to European standard ED 13432 (2000), a material must exhibit a biodegradation of at least 90 percent in total, or a biodegradation of at least 90 percent of the maximum degradation of a suitable reference material after a plateau has been reached for both the reference and test item. The maximum test duration for biodegradability under industrial compositing conditions is 180 days.

In order to be considered “biodegradable,” under soil composting conditions according the OK biodegradable SOIL conformity mark of Vinçotte and the DIN Geprüft Biodegradable in soil certification scheme of DIN CERTCO, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradability under soil compositing conditions is 2 years.

As used herein, the term “blow up ratio” means the ratio of the inner diameter of the extruder die to the outer diameter of the outer mandrel.

### Claims not Limited to Disclosed Embodiments

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

### EXPERIMENTAL SECTION

### Abbreviations

BUR is blow up ratio; wt % is weight percent; BA is blowing agent; Foam sheet samples were made on a tandem foam line manufactured by Krauss Maffei. The extrusion lines consists of a ZE30 twin screw extruder as the primary extruder coupled to a KE60 single screw extruder as the secondary cooling extruder. Formulation additives are dosed in to the KE30 twin screw feeder using loss and weight feeders. Physical blowing agents are injected into the barrel of the primary extruder about ½ to ⅔ down the barrel of the primary extruder. Material is extruded out a 50 mm annual die and conveyed over a sizing mandrel. The annular film is then slit and turned into a flat film in the tension/take up station part of the roll.

Material composition is a cellulose acetate resin having 15 to 20 weight % processing aid and stabilizers. The material is injected with n-pentane as the blowing agent. Additional additives to the process include 1 wt % ABT 1000 talc and a 1% of a chemical blowing agent. The material were extruded between 20° and 220° C. in the primary extruder and 170-190° C. in the secondary extruder. The output rate of the line was 40 kgs/hr.

Blow up ratio and lay flat width are important items for foam. The blow up ratio (BUR) is defined as the diameter of the sizing mandrel or calibration divided by the diameter of the die. The lay flat width is the mandrel diameter multiplied by the constant PI (3.14159).

$$Blow up Ratio : BUR = Diameter of the Mandrel / Diameter of the Die$$

TABLE 1

| Die Diameter (mm) | Sizing Mandrel Diameter (mm) | BUR |
|---|---|---|
| 50 | 120 | 2.4 |
| 50 | 140 | 2.8 |
| 50 | 160 | 3.2 |
| 50 | 200 | 4.0 |

Applications have certain stiffness requirements which is primarily controlled with resin modulus and article thickness. The table below illustrates some common material thickness used in commercial applications today.

TABLE 2

| Application | Thickness |
|---|---|
| Small meat trays | 4 to 6 mm |
| Large meat trays | 5 to 7 mm |
| Clamshells | 2 to 4 mm |
| Cafeteria Trays | 3 to 6 mm |
| Egg Cartons | 2 to 4 mm |
| Plates | 2 to 4 mm |
| Bowls | 2 to 4 mm |

Achieving the ideal target thickness for foam is complicated. As its related to the output rate and take off speed much like other extrusion processes; however, it is also impacted by the mandrel sizing as well as the foam efficacy. The foam behavior is also influences by many variables including physical blowing agent type and level, chemical blowing agent type and level, nucleator type and level, temperature and pressures etc.

Table 3 illustrates how the thickness of the foam at a BUR of 3.2 can be influenced by the physical blowing agent level. Thicknesses up to 5 mm are possible through further optimization of the process. When the BUR is 2.8 as in Table 2, even greater thickness can be achieved up to almost 7 mm in thickness by varying the physical blowing agent level.

TABLE 3
Impact of Blowing Agent Level on Maximum Average Thickness at BUR of 3.2.

| | | | Mandrel | BA, | Line | | Average | |
|---|---|---|---|---|---|---|---|---|
| Ex | | Triacetin | size | Pentane | speed | Density | Thickness | |
| # | BUR | (wt %) | (mm) | (wt %) | (m/min) | (g/cc) | (mm) | Corrugation |
| 1 | 3.2 | 30 | 160 | 2.3 | 3.5 | 0.108 | 3.53 | None |
| 2 | 3.2 | 20 | 160 | 2.5 | 3.8 | 0.103 | 4.10 | None |
| 3 | 3.2 | 15 | 160 | 2.3 | 5.4 | 0.094 | 2.52 | None |
| 4 | 3.2 | 15 | 160 | 2.5 | 4.6 | 0.100 | 3.20 | None |

TABLE 4
Impact of Blowing Agent Level on Maximum Average Thickness at BUR of 2.8.

| | | | Mandrel | BA, | Line | | Average | |
|---|---|---|---|---|---|---|---|---|
| Ex | | Triacetin | size | Pentane | speed | Density | Thickness | |
| # | BUR | (wt %) | (mm) | (wt %) | (m/min) | (g/cc) | (mm) | Corrugation |
| 5 | 2.8 | 20 | 140 | 2.5 | 3.2 | 0.098 | 5.38 | None |
| 6 | 2.8 | 20 | 140 | 2.7 | 3.3 | 0.097 | 5.97 | None |
| 7 | 2.8 | 20 | 140 | 2.9 | 3.0 | 0.090 | 6.50 | None |
| 8 | 2.8 | 20 | 140 | 2.7 | 3.3 | 0.092 | 5.89 | None |

TABLE 5
Impact of BUR on Max Thickness

| | | Processing | Mandrel | BA, | Line | | Average | |
|---|---|---|---|---|---|---|---|---|
| Ex | | aid | size | Pentane | speed | Density | Thickness | |
| # | BUR | (wt %) | (mm) | (wt %) | (m/min) | (g/cc) | (mm) | Corrugation |
| 9 | 2.4 | 20 | 120 | 2.5 | 3.3 | 0.096 | 6.06 | High |
| 10 | 2.8 | 20 | 140 | 2.5 | 3.2 | 0.098 | 5.38 | Low |
| 11 | 3.2 | 20 | 160 | 2.5 | 3.8 | 0.103 | 4.10 | None |
| 12 | 4.0 | 20 | 200 | 2.5 | 8 | 0.102 | 1.35 | None |
| 13 | 2.4 | 15 | 120 | 2.5 | 3.7 | 0.093 | 5.72 | High |
| 14 | 2.8 | 15 | 140 | 2.5 | 4.1 | 0.109 | 5.20 | None |
| 15 | 3.2 | 15 | 160 | 2.5 | 4.6 | 0.100 | 3.20 | None |

| | | | | | |
|---|---|---|---|---|---|
| 16 | 4.0 | 15 | 200 | 2.5 | Sample failed to stretch over mandrel |

Line Rate Ratio is defined as the:

$$Output rate ( kgs / min ) / Line Speed ( M / min ) = Line Rate Ratio Kg / M$$

Line speed is the operating speed of the pull roll assembly which winds the foam into a roll. Line Rate Ratio allows for scaling the product as extruders increase in size from small (20-40 Kg/h) to large (500-1000 kg/h).

TABLE 6

| Output rate | Output rate | Line Speed | Line Rate |
|---|---|---|---|
| kgs/hr | (Kgs/min) | (M/min) | Ratio Kg/M |
| 40 | 0.7 | 2 | 0.33 |
| 40 | 0.7 | 7 | 0.10 |
| 499 | 8.3 | 38.1 | 0.22 |
| 499 | 8.3 | 52 | 0.16 |
| 590 | 9.8 | 38.1 | 0.26 |
| 590 | 9.8 | 52 | 0.19 |
| 816 | 13.6 | 55 | 0.25 |
| 816 | 13.6 | 69 | 0.20 |
| 907 | 15.1 | 55 | 0.27 |
| 907 | 15.1 | 69 | 0.22 |

1. A foam sheet forming process, the process comprising:
(a) extruding a composition comprising a cellulose ester through an annular die having a die inner diameter (X) to form a tubular extrudate; and
(b) drawing the tubular extrudate over a forming mandrel having a mandrel outer diameter of 2.1X to 3.9X.

2. The foam sheet forming process of claim 1, further comprising processing the tubular extrudate to form a foamed sheet.

3. The foam sheet forming process of claim 2, wherein the foamed sheet has a density of from 0.05 to 0.12 g/cm³.

4. The foam sheet forming process of claim 1, wherein the composition comprises from 2.0 to 5 wt % of one or more of a physical blowing agent.

5. The foam sheet forming process of claim 1, wherein the line rate ratio is from 0.10 to 0.33 kg/m.

6. The foam sheet forming process of claim 2, wherein the foamed sheet has a thickness of from 2 to 7 mm, and the mandrel outer diameter is from 2.5X to 3.6X.

7. The foam sheet forming process of claim 1, wherein the line rate ratio is from 0.1 to 0.28 kg/m.

8. The foam sheet forming process of claim 2, wherein the foamed sheet has a thickness of from 4 to 7 mm, and the mandrel outer diameter is from 2.5X to 3.3X.

9. The foam sheet forming process of claim 2, wherein the line rate ratio is from 0.19 to 0.33 kg/m.

10. The foam sheet forming process of claim 2, wherein the foamed sheet has a thickness of from 2 to 4 mm, and the mandrel outer diameter is 3.0X to 3.9X.

11. The foam sheet forming process of claim 1, wherein the line rate ratio is from 0.1 to 0.22 kg/m.

12. The foam sheet forming process of claim 1, the extrudate or foam sheet has less than 5 corrugations.

13. The foam sheet forming process of claim 1, wherein the composition has a glass transition temperature (Tg), and the composition is extruded through the annular die (a) at a temperature of at least 40° C. above the Tg of the composition.

14. The foam sheet forming process of claim 13, wherein the composition is extruded (a) at a temperature of at least 160° C.

15. The foam sheet forming process of claim 1, wherein the forming mandrel has an exterior surface temperature of greater than 30° C.

16. The foam sheet forming process of claim 1, wherein the composition comprises 1% to 50% by weight one or more polymers and/or one or more additives operable to increase the elasticity and/or melt strength of the composition, based on the total weight of the composition.

17. The foam sheet forming process of claim 16, wherein the one or more polymers have a glass transition temperature (Tg) of below room temperature.

18. The foam sheet forming process of claim 17, wherein the one or more additives are operable to reduce the Tg of the composition.

19. The foam sheet forming process of claim 16, wherein the one or more additives comprise chemical blowing agents, physical blowing agents, co-blowing agents, surface modifying additives, elastic polymers, and melt strength enhancers.

20. The foam sheet forming process of claim 19, wherein the one or more additives comprises a functional ionic component as the melt strength enhancer.

21. The foam sheet forming process of claim 20, wherein the functional ionic component is selected from the group consisting of acacia gum, sulfopolyesters, quaternary salts, ionomers, ionic liquids, ionic waxes, and mixtures thereof.

22. The foam sheet forming process of claim 1, wherein the composition comprises a blend comprising cellulose acetate and a biodegradable polymer selected from the group consisting of polyethylene succinate (PES), poly(glycolic acid) (PGA), starch, and mixtures thereof.
